(19) United States
(12) Patent Application Publication
(10) Pub. No.: US 2012/0008004 A1
(43) Pub. Date: Jan. 12, 2012

(54) LIGHTING IDENTIFICATION

(75) Inventor: Timothy Kerby, Edinburgh (GB)

(73) Assignee: STMicroelectronics (Research & Development) Limite, Marlow (GB)

(21) Appl. No.: 13/113,659

(22) Filed: May 23, 2011

(30) Foreign Application Priority Data
May 24, 2010 (GB) 1008602.3

(51) Int. Cl. G06K 9/00; H04N 5/228

(52) U.S. Cl. 348/222.1; 382/165; 348/E05.031

(57) ABSTRACT

A lighting identification chart has a grey patch lighting identification feature and a three-part fiduciary marker positioned around the grey patch. The lighting identification chart 102 can be a small 18% reflectance ‘grey card’ produced with a fiduciary marker pattern on its surface. An imaging algorithm determines the orientation of the card with respect to the camera and locates the area of the grey patch. During image capture, the subject presents the card within the frame. The camera recognizes the locating features and calculates a white balance based on the grey patch on the card.

### PRIORITY CLAIM

This application claims priority from United Kingdom Application for Patent No. GB 1008602.3 filed May 24, 2010, the disclosure of which is hereby incorporated by reference.

### TECHNICAL FIELD

This disclosure relates to a lighting identification chart and methods of its use.

### BACKGROUND

In the field of photography, identifying the lighting illuminating a scene is a difficult problem which has implications for white balance and also the selection of shading correction and color matrices.

Current automatic methods center on identifying a locus representing white objects under different lighting conditions. The further away from the locus, the lower the weight the object has within the statistics. This works well in many situations, but is less effective when colored objects look similar to a white object under a different light. For example, a sky blue business card in indoor lighting may look the same as a white piece of paper outside.

Manual white balance can be performed, using the well-known ‘grey card’ with a patch or covering of grey acting as a lighting identification feature. The grey card is held near the camera and light reflected off the card is detected and used to find the white balance for a central region in the image frame. The camera is then set to this value for subsequent photographs. This does, however, rely on the light at the card remaining similar to that at the subject. It also requires the user to: operate the camera in a special mode, manually frame the grey card, and then activate the extraction of lighting information from the image of the grey area. Alternatively, the grey card may be included in a test photograph that is taken, then further manual processing is required to identify and view the test photograph, to manually specify the location of the image of the grey card, and to activate extraction of the lighting information from the manually identified image of the grey card. This may be done, for example, in image processing software by choosing a white balance mode then clicking on the image of the grey card in the frame. The lighting information is then used to adjust the color balance of photographs that the user manually identifies as being taken under the same lighting conditions.

The standard Munsell Color Checker camera profiling chart (also known as a MacBeth Color Checker) has a grid of patches of different colors as the lighting identification feature. It is used in the same way as a grey card with a test frame being captured, but it requires more careful manual alignment for its image to be captured in the frame.

Another lighting identification chart is defined by the American National Standards Institute (ANSI) standard “IT8.7/2-1993 (R2003) Graphic technology—Color Reflection Target for Input Scanner Calibration.” This chart is used for calibrating scanners. In use, the IT8 color chart is manually aligned upon loading into a scanner bed for a prescan. Using the prescan, a further manual alignment is performed in software by the user to position a grid over the IT8 target before the calibration scan is performed.

A fiduciary marker is an object used in the field of view of an imaging system which appears in the image produced, for use as a point of reference or a measure.

### SUMMARY

According to an embodiment, there is provided a lighting identification chart comprising a lighting identification feature and a fiduciary marker. The fiduciary marker comprises at least three separate fiduciary marks spaced across a surface of the lighting identification chart. These three separate fiduciary marks are placed around the lighting identification feature.

According to an embodiment, a method of using a lighting identification chart includes receiving an image frame comprising an image of a lighting identification chart. The image of the lighting identification chart comprises an image of a lighting identification feature and an image of a fiduciary marker. The image frame is processed to recognize the image of the fiduciary marker. The location of the image of the lighting identification feature in the image frame is also determined. This determination uses the recognized image of the fiduciary marker. The determination also uses information about the relative position on the lighting identification chart of the fiduciary marker and the lighting identification feature. Lighting information is then extracted from the image of the lighting identification feature using the determined location.

### BRIEF DESCRIPTION OF THE DRAWINGS

The present disclosure will now be described by way of example only with reference to the accompanying Figures, in which:

FIG. 1 illustrates, in schematic form, use of a lighting identification chart, in accordance with an embodiment of the present disclosure;

FIG. 2 is a flowchart of a method of using a lighting identification chart according to an embodiment of the present disclosure;

FIG. 3 is a flowchart of a method of using a lighting identification chart according to another embodiment of the present disclosure;

FIG. 4 illustrates, in schematic form, a self-similar fiduciary mark;

FIG. 5 illustrates, in schematic form, a self-similar barcode fiduciary mark; and

FIG. 6 illustrates, in schematic form, an enlarged pixel of a self-similar barcode fiduciary mark.

### DETAILED DESCRIPTION OF THE DRAWINGS

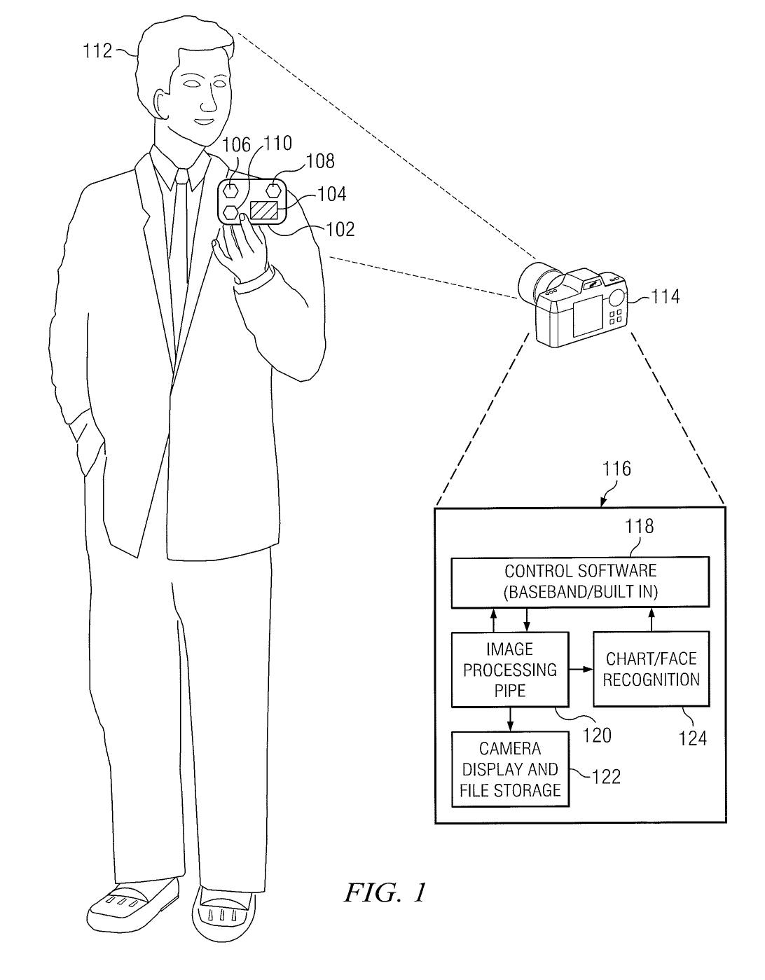

With reference to FIG. 1, a lighting identification chart 102 has a grey patch lighting identification feature 104 and a three-part fiduciary marker 106, 108, 110. The grey patch 104 may cover the whole face of a card, and thus the lighting identification chart 102 can be a small 18% reflectance ‘grey card’ produced with a fiduciary marker pattern on its surface.

In this embodiment, the fiduciary marker comprises three separate fiduciary marks or locating features 106, 108, 110 spaced across a surface of the chart. This allows the imaging algorithm to determine the orientation of the card with respect to the camera and to locate the area of the grey patch 104. The separate fiduciary marks may be placed around the grey patch 104. Because they are further apart on the surface, a more accurate determination of any transformation that needs to be applied to locate the grey patch 104 may be made. Thus, the number and arrangement of the markers may be sufficient to reliably indentify the orientation of the chart, even as it appears different when as it is tilted towards or away from camera. In another embodiment, a single fiduciary marker is provided.

During image capture, the subject 112 presents the card 102 within the frame. A camera 114 recognizes the locating features 106, 108, 110 and calculates a white balance based on the area of the grey patch 104 on the card 102. An exposure may also be calculated. The card may then be hidden from view of the camera 114 while these values are stored and a photograph is taken by the camera 114 with the determined white balance settings applied.

Instead of a grey patch, the lighting identification feature 104 may contain patches with different spectral reflectance or identified metamerism to allow more information about the light source to be determined. This may help differentiate between, for instance, a U30 fluorescent and an incandescent light, which, while they may have similar white balance, often require considerably different color matrix or shading correction.

In another embodiment, the lighting identification feature 104 comprises a Munsell Color Checker chart which is used for color referencing.

The fiduciary marker 106, 108, 110 may be a separate structure from the lighting identification feature 104 portion of the chart. According to another embodiment, a single element may perform both functions. For example, a series of concentric circles that have different colors may serve as both a fiduciary marker and a lighting identification feature. In this embodiment, the fiduciary marker comprises the lighting identification feature.

The camera 114 may be a digital still camera, mobile phone, PDA, video camera, camcorder or other such device having an image sensor.

The camera 114 has a microprocessor, which may control some or all of the functions of the camera's architecture 116 as illustrated in FIG. 1. The control software (baseband/built-in) 118 is in functional communication with the image processing pipe 120. The image processing pipe 120 outputs to the camera display and file storage 122 and to the chart/face recognition module 124, which outputs the results of its recognition process back to the control software 118.

The lighting identification feature 104 and the fiduciary marker 106, 108, 110 may be printed on or attached to or otherwise supported by a camera case or lens cap or by a housing of a mobile telephone, or some other accessory associated with the camera 114. Thus, access to the chart 102 may be convenient if required in difficult lighting.

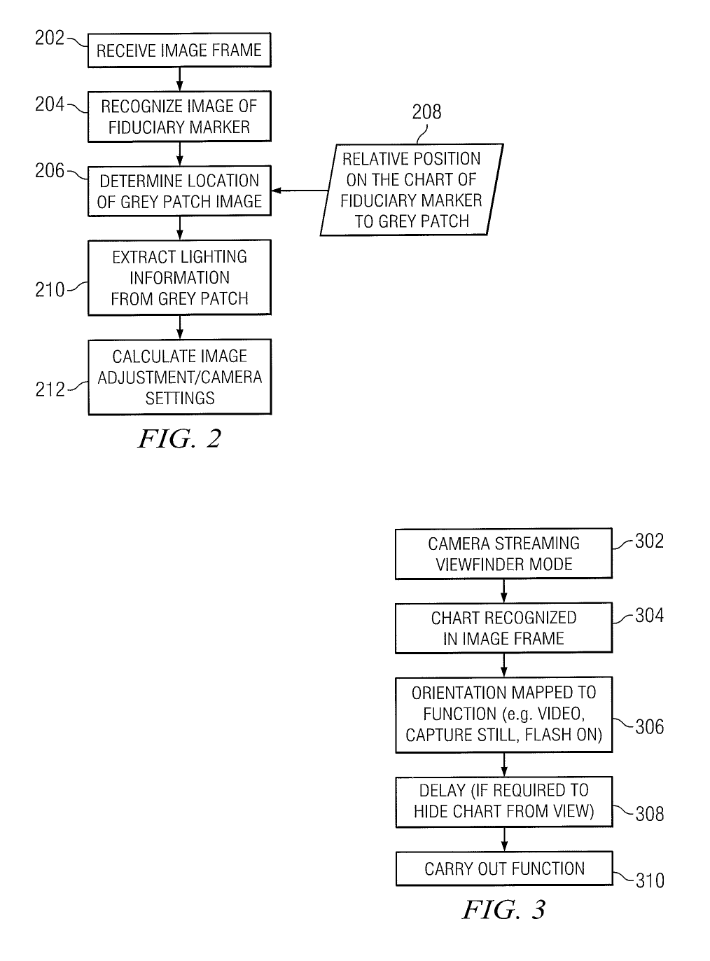

With reference to FIG. 2, at step 202, the camera receives an image frame comprising an image of a lighting identification chart 102 that itself includes images of the grey patch 104 and the fiduciary marker 106, 108, 110. The camera processes the image frame to recognize the image of the fiduciary marker at step 204. At step 206, the camera 114 determines the location of the image of the grey patch 104 in the image frame using both the recognized image of the fiduciary marker 106, 108, 110 and information about the relative position on the lighting identification chart of the fiduciary marker 106, 108, 110 and the grey patch 104. The information may be specific relative coordinate data or hard-coded information that the grey patch 104 will be found by searching the image frame adjacent to the fiduciary marker 106, 108, 110. The camera 114 then extracts lighting information from the image of the grey patch 104 using the determined location of the image of the grey patch 104 at step 210. Finally, at step 212, the camera calculates an image adjustment, such as adjustment parameters or camera settings based on the extracted lighting information.

In another embodiment illustrated in FIG. 3, while the camera 114 is operating in streaming viewfinder mode at step 302, the chart 102 is recognized in an image frame at step 304. The camera determines the orientation of the image of the fiduciary marker and/or the chart in the image frame using the recognized image of the fiduciary marker. A camera control function may then be selected based on the determined orientation at step 306. The orientation may be mapped to a function such as video, still photograph capture, or flash on, which is then carried out by the camera at step 310. Thus, the chart 102 may be used as a low cost remote control. In one embodiment, the recognition of the chart by the image processing software results in a presence flag being set, which then activates the microprocessor to perform a command function.

According to one embodiment, at step 308, the card may also be used to control the camera by delaying a self timer until the card 102 has been hidden. This delay may also allow others to join the group or allow multiple photos to be taken by showing it again.

The camera may thus perform these camera control steps after extracting information from the light patch in accordance with the method described with reference to FIG. 2. To this end, the camera may receive a subsequent image frame and process it to recognize the image of the fiduciary marker and control a camera function based on the absence of recognition of the image of the fiduciary marker.

The camera may also automatically determine the extent of the unwanted image of the grey card in a photograph using the recognized image of the fiduciary marker. The image frame may be automatically processed to edit out the unwanted image. For example, should the card be present within a photo, this post processing may identify the card and automatically edit it out of the shot through intelligent cloning of nearby regions.

When the lighting conditions are known, the chart can be used to determine part-to-part reference calibration of image sensors. In this manner, the performance of one image sensor may be compared with the performance of another image sensor.

In an embodiment of the present disclosure, the lighting identification chart is automatically recognized by the software of the camera so the user can just point and click, and the lighting identification using the chart is performed automatically, instead of having to take two separate images, one with the chart and one without.

This fiduciary marker is designed with a shape and/or pattern to be easily recognized by imaging algorithms at different sizes within the frame. A self-similar pattern for the fiduciary marker may be used, as some of the area should be recognized at different magnifications. According to an embodiment, the fiduciary marker may comprise concentric circles.

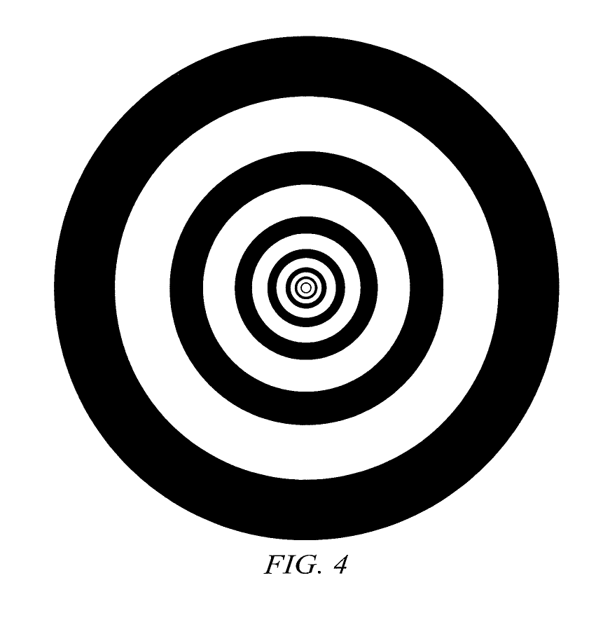

FIG. 4 illustrates, in schematic form, a self-similar fiduciary marker having concentric circles. The small circles appear the same close up as the larger circles appear far away.

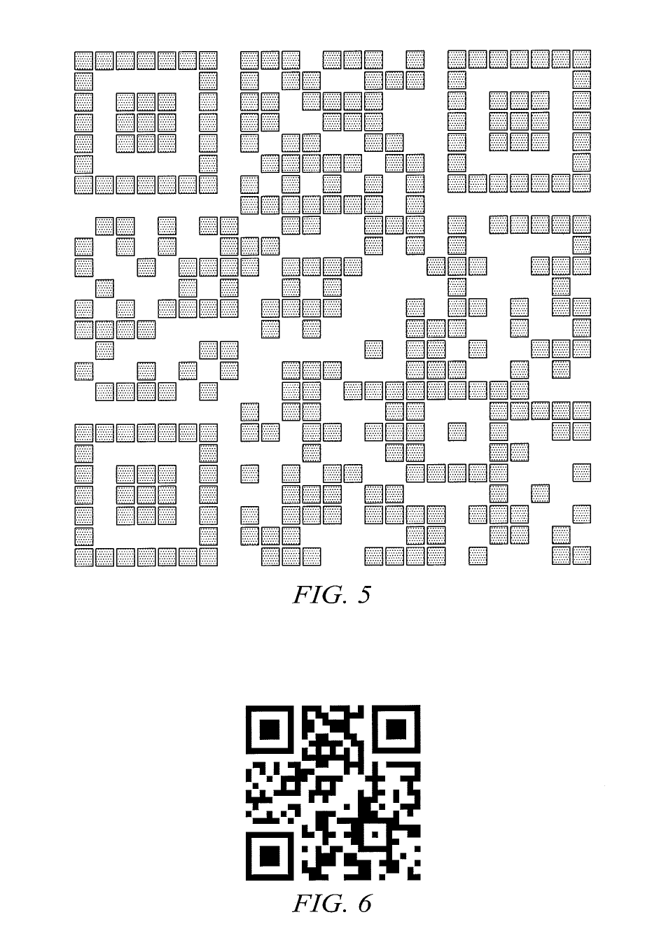

FIG. 5 illustrates a self-similar barcode fiduciary marker. The barcode is a QR code as an example. Each pixel contains a shrunken copy of the barcode, as shown in FIG. 6. The barcode may be read both at a distance, where the smaller pattern is blurred, and close up across its area. In this example, the text encoded in the barcode is http://www.st.com. The contrast on the smaller pattern has also been lowered slightly to ensure the large barcode can be read across a number of distances.

FIG. 6 illustrates an enlarged pixel of a self-similar barcode fiduciary marker.

Further modifications and improvements may be added without departing from the scope of the disclosure herein described.

What is claimed is:

1. A lighting identification chart comprising a lighting identification feature and a fiduciary marker, wherein the fiduciary marker comprises at least three separate fiduciary marks spaced across a surface of the lighting identification chart and said at least three separate fiduciary marks are placed around the lighting identification feature.

2. The lighting identification chart of claim 1, wherein the lighting identification feature comprises a grey patch.

3. The lighting identification chart of claim 1, wherein the lighting identification feature comprises a plurality of patches of different colors.

4. The lighting identification chart of claim 3, wherein the lighting identification feature comprises a Munsell Color Checker chart.

5. The lighting identification chart of claim 1, wherein the fiduciary marker comprises a self-similar pattern.

6. The lighting identification chart of claim 1, wherein the fiduciary marker comprises concentric circles.

7. The lighting identification chart of claim 1, wherein the fiduciary marker comprises the lighting identification feature.

8. The lighting identification chart of claim 1, wherein the lighting identification feature and the fiduciary marker are each supported by a camera case.

9. The lighting identification chart of claim 1, wherein the lighting identification feature and the fiduciary marker are each supported by a housing of a mobile telephone.

10. A method of using a lighting identification chart, comprising:
receiving an image frame comprising an image of a lighting identification chart, the image of the lighting identification chart comprising an image of a lighting identification feature and an image of a fiduciary marker;
processing the image frame to recognize the image of the fiduciary marker;
determining the location of the image of the lighting identification feature in the image frame using:
the recognized image of the fiduciary marker; and
information about the relative position on the lighting identification chart of the fiduciary marker and the lighting identification feature; and
extracting lighting information from the image of the lighting identification feature using the determined location.

11. The method according to claim 10, further comprising calculating an image adjustment based on the extracted lighting information.

12. The method according to claim 10, further comprising:
determining an orientation of the image of the fiduciary marker in the image frame using the recognized image of the fiduciary marker; and
selecting a camera control function based on the determined orientation.

13. The method according to claim 10, further comprising:
determining a presence of an unwanted image of the lighting identification chart in a subsequent image frame using the recognized image of the fiduciary marker; and
automatically processing the subsequent image frame to edit out the unwanted image.

14. The method according to claim 10, further comprising:
receiving a subsequent image frame;
processing the subsequent image frame to determine whether an image of the fiduciary marker is present; and
controlling a camera function based on the absence of the presence of the subsequent image of the fiduciary marker.

15. A lighting identification system, comprising:
a camera having a microprocessor, the microprocessor being programmed to perform functions comprising:
receiving an image frame comprising an image of a lighting identification chart, the image of the lighting identification chart comprising an image of a lighting identification feature and an image of a fiduciary marker;
recognizing the image of the fiduciary marker in the image frame;
determining the location of the image of the lighting identification feature in the image frame using the recognized image of the fiduciary marker, and information about the relative position on the lighting identification chart of the fiduciary marker and the lighting identification feature; and
extracting lighting information from the image of the lighting identification feature using the determined location.

16. The system of claim 15 wherein the microprocessor is programmed to perform functions further comprising calculating an image adjustment based on the extracted lighting information.

17. The system of claim 15 wherein the microprocessor is programmed to perform functions further comprising:
determining an orientation of the image of the fiduciary marker in the image frame using the recognized image of the fiduciary marker; and
selecting a camera control function based on the determined orientation.

18. The system of claim 15 wherein the microprocessor is programmed to perform functions further comprising:
determining a presence of an unwanted image of the lighting identification chart in a second image frame using the recognized image of the fiduciary marker; and
automatically editing the image frame to remove the unwanted image.

19. The system of claim 15 wherein the microprocessor is programmed to perform functions further comprising:
receiving a subsequent image frame;
determining whether a subsequent image of the fiduciary marker is present in the subsequent image frame; and
controlling a camera function based on the absence of the presence of the image of the fiduciary marker.
